(19) United States
(12) Patent Application Publication
(10) Pub. No.: US 2021/0276735 A1
(43) Pub. Date: Sep. 9, 2021

(54) GROUND STATION FOR UNMANNED AERIAL VEHICLES

(71) Applicant: Matternet, Inc., Mountain View, CA (US)

(72) Inventors: Andreas RAPTOPOULOS, Palo Alto, CA (US); Paolo RESMINI, Mountain View, CA (US); Ido BARUCHIN, San Francisco, CA (US); Lalo RUIZ, Mountain View, CA (US); David WELDON, Mountain View, CA (US); Jon BYARS, Mountain View, CA (US); Jim O'SULLIVAN, Mountain View, CA (US); Alex WU, Mountain View, CA (US); David TSAI, Mountain View, CA (US); Martin NOVAK, Mountain View, CA (US)

(73) Assignee: Matternet, Inc., Mountain View, CA (US)

(21) Appl. No.: 17/195,487

(22) Filed: Mar. 8, 2021

Related U.S. Application Data
(60) Provisional application No. 62/987,302, filed on Mar. 9, 2020.

(51) Int. Cl. B64F 1/32; B64F 5/60; B64F 1/22; G08G 5/00

(52) U.S. Cl. CPC B64F 1/322; B64F 5/60; G08G 5/0026; G08G 5/0082; B64F 1/222

(57) ABSTRACT

This disclosure describes a ground station configured to facilitate the delivery of payloads using unmanned aerial vehicle (UAV). The ground station includes multiple sensors that allow for autonomous operation of the ground station as part of a larger payload transportation system. The sensors are configured to confirm loading of payloads onto a UAV, checking a status and safety of the drone and clearing an area surrounding the ground station prior to takeoff and/or landing operations of the UAV.

### CROSS-REFERENCE TO RELATED APPLICATIONS

This application claims priority to U.S. Provisional Patent Application 62/987,302, titled, “GROUND STATION FOR UNMANNED AERIAL VEHICLES,” filed Mar. 9, 2020, the content of which is hereby incorporated by reference in its entirety.

### FIELD

The present disclosure relates generally to a ground station used as a landing pad and loading/unloading station for unmanned aerial vehicles (UAVs). More particularly, the ground station also includes a customer-facing interface through which customers can securely drop off and receive packages meant for transport by the UAVs.

### BACKGROUND

Unmanned aerial vehicles (UAVs) or drones are increasingly being used for various personal or commercial applications. Nowadays, transportation of packages heavily relies on ground infrastructures using transporting vehicles such as delivery trucks. While UAVs are being used to deliver some packages in recent years, they are limited by the range of flight because they are usually launched from a fixed distribution facility. As a result, the current UAV transportation systems may not be flexible to deliver packages to a widespread area such as a city or multiple neighborhoods. Therefore, there is a need to integrate the UAVs with a network of distributed ground stations, to provide flexibility and mobility for transporting packages to multiple locations.

### SUMMARY

A ground station for receiving a payload container from an unmanned aerial vehicle (UAV) is provided. The landing platform comprises one or more landing subsystems configured to coordinate with the UAV for landing; one or more sensors for detecting the landing of the UAV on the landing platform; one or more actuators configured to align the UAV for receiving the payload container; a payload receiving structure of the landing platform configured to receive the payload container from the UAV; a customer-facing interface for receiving a payload from and delivering the payload to a customer; a payload loading structure of the landing platform configured to load a new payload and/or battery on to the UAV; and inspection equipment for performing automated preflight analysis of the UAV prior to allowing the UAV to perform subsequent flights.

A method for managing supervision of active unmanned aerial vehicles is described and includes: receiving updated information related to the active unmanned aerial vehicles; determining a likelihood of two or more of the unmanned aerial vehicles concurrently requiring input from a flight director; and in accordance with a determination that the likelihood of two or more of the unmanned aerial vehicles concurrently requiring input from a flight director has exceeded a predetermined threshold, sending a notification indicating a number of flight directors needed to supervise the active unmanned aerial vehicles based on the likelihood exceeding the predetermined threshold.

The terminology used in the description of the various described embodiments herein is for the purpose of describing particular embodiments only and is not intended to be limiting. As used in the description of the various described embodiments and the appended claims, the singular forms “a”, “an,” and “the” are intended to include the plural forms as well, unless the context clearly indicates otherwise.

It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The details of one or more embodiments of the subject matter described in the specification are set forth in the accompanying drawings and the description below. Other features, aspects, and advantages of the subject matter will become apparent from the description, the drawings, and the claims.

### DESCRIPTION OF THE FIGURES

FIG. 1 shows an exemplary system for payload transportation using UAVs, consistent with some embodiments of the present disclosure.

FIGS. 2A-2K show views of an exemplary ground station.

FIGS. 3A-3D show different views of a user interface for use by a UAV flight director.

FIGS. 4A-4E show different examples of reduced functionality ground stations.

### DETAILED DESCRIPTION

The following description sets forth exemplary systems and methods for transportation using UAVs. The illustrated components and steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

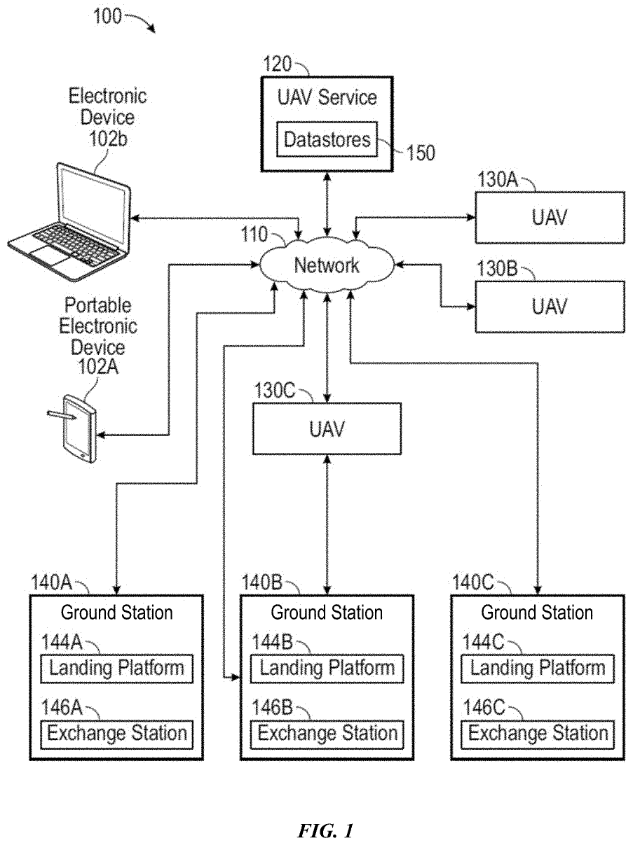

FIG. 1 illustrates an exemplary payload transportation system 100 using UAVs, consistent with some embodiments of the present disclosure. Referring to FIG. 1, payload transportation system 100 can include one or more portable electronic devices 102A-B (collectively referred as portable electronic devices 102), a network 110, a UAV service 120, one or more UAVs 130A-C (collectively referred as UAVs 130), and one or more ground stations 140A-C (collectively referred as ground stations 140). Payload transportation system 100 can enable or facilitate requesting, scheduling, controlling, and/or navigating of UAVs for transporting payloads to locations.

Portable electronic devices 102A and electronic device 102B include devices that can request, schedule, or facilitate payload transportation through various means. Electronic devices 102A-B can communicate with UAV service 120, UAV 130, and/or UAV station 140 either directly or indirectly through a network 110. As an example, portable electronic device 102A can communicate directly with or identify the payload carried by UAV 130A. As another example, portable electronic device 102A can communicate indirectly with UAV service 120 through network 110 to request payload transportation or to provide payload identifications. While electronic devices 102A-B are portrayed as a computer or a laptop (e.g., portable electronic device 102A), a tablet, and a mobile smart phone (e.g., portable electronic device 102B), it is appreciated that portable electronic devices 102A-B could be any other type of electronic device that communicates data such as a desktop computer, a server or a wearable electronic device.

Network 110 can be any type of network that facilitates wired and/or wireless communications. For example, network 110 can be a cellular network (e.g., GSM, GPRS, CDMA, LTE), a wide-area network (WAN), a local area network (LAN), a radio network, a satellite network, a Wi-Fi network, a near-filed communication network, Zigbee, Xbee, XRF, Xtend, Bluetooth, WPAN, line of sight, satellite relay, or any other wired or wireless network, or a combination thereof.

UAV service 120 can communicate with one or more components of payload transportation system 100, such as electronic devices 102, UAVs 130, and UAV stations 140, to facilitate payload transportation using UAVs. For example, based on communication with electronic devices 102, UAV service 120 can receive requests for transporting a payload, an identification of the payload to be transported, and an identifications of a payload container. Based on the request or information received, UAV service 120 can determine a UAV flight route for transporting the payload to its destination location. UAV service 120 can communicate the flight route information to the UAV that carries the payload. In some embodiments, UAV service 120 may continue to communicate with the UAV during the flight. After the payload is transported, UAV service 120 may receive a confirmation or notification of completion. UAV service 120 may include, for example, one or more geospatial data stores, geospatial caches, one or more application servers, one or more application data stores, one or more messaging queues, and tracking data. UAV service 120 may be provided on a desktop computer, a laptop computer, a server (physical or virtual), or a server farm.

In some embodiments, UAV service 120 can include one or more datastores 150. Datastores 150 may include, for example, a time series datastore and a geospatial datastore. A time series datastore may be a software system for handling time series data and arrays of numbers indexed by time (e.g., a datetime or a datetime range). In some embodiments, UAVs 130 can transmit telemetry and sensor data to a system for storage within a time series datastore or a tracking datastore. These time series may also be called as profiles, curves, or traces. An application server of UAV service 120 may further monitor the time series datastore and/or the tracking datastore to determine trends such as UAV components that require maintenance based on the stored time series data or tracking data.

In some embodiments, a geospatial data store can be an object-relational spatial database that includes latitude and longitude data. Example data and data sources for a geospatial data store include, but are not limited to, terrain data from the National Aeronautics and Space Administration (“NASA”), airspace data from the Federal Aviation Administration (“FAA”), geospatial data from the National Park Service, Department of Defense, and/or other federal agencies, geospatial and/or building data from local agencies such as school districts, and/or some combination thereof. A geospatial data store may include large amounts of data such as hundreds of gigabytes of data or terabytes of data.

In some embodiments, UAV service 120 can include one or more application servers and message brokers. Application servers can perform various tasks such as processing authentication and authorization, maintaining general purpose data (e.g., UAV names, configurations, flight routes, UAV stations). Message brokers can enable data movement between software components or systems in substantially real time for providing authentication and authorization.

UAV 130 can communicate with one or more components of payload transportation system 100, such as UAV service 120 and ground stations 140, and one or more satellites (not shown) to transport a payload. For example, UAV 130A communicates with UAV service 120 to obtain a flight route for transporting the payload, picks up a payload container with the payload to be transported, autonomously navigates using the flight route and satellites signals, and transports the payload to its destination location such as a ground station 140. UAV 130 can include, for example, a body with an optional payload carrying space, one or more propellers or fixed wings, a releasable and/or exchangeable battery, and a releasable and/or exchangeable payload container.

Ground station 140 can communicate with one or more components, devices, or systems of payload transportation system 100, such as UAV service 120 and UAV 130 to facilitate payload transportation. In some embodiments, ground station 140 can include a secure landing platform 144 and an exchange station 146. A landing platform facilitates landing and launching of a UAV 130. In some embodiments, the landing platform also includes doors and/or petals for securing one or more of UAVs 130 within an enclosed space defined by ground station 140. An exchange station 146 can receive a payload, a payload container, or a battery from a UAV 130; load a payload, a payload container, or a battery to a UAV 130, or exchange a payload, a payload container, or a battery with a UAV 130. UAV station 140 can be a fixed station dedicated for transporting multiple payloads. For example, ground station 140 may be located in a known position and configured to house multiple payloads for transportation and/or delivery to an end user. In accordance with the information received from UAV service 120 (e.g., flight route, payload information, etc.), one or more UAVs 130 may be launched from a ground station 140 to transport payloads to their destination locations (e.g., another ground station 140, a residential address, or a business address). In addition, a ground station 140 can also receive one or more UAVs 130. For example, a ground station 140 can include a landing platform 144 and an exchange station 146. To receive a payload, landing platform 144 communicates with UAV 130 to assist landing of a UAV 130 on landing platform 144. In some embodiments, landing platform 144 can align or adjust the position of the landed UAV 130 such that the payload container can be released from UAV 130 to a payload receiving structure of landing platform 144. For example, landing platform 144 can include a center opening for receiving or exchanging payload containers. In some embodiments, after UAV 130 releases its payload container to exchange station 146, it can receive another payload container from exchange station 146 for transporting it to the next destination location.

Ground station 140 can also include a suite of sensors configured to clear the airspace surrounding a ground station 140 prior to initiating takeoff or terminal landing operations and perform inspection of UAV 130 once positioned on or within ground station 140. These sensors can take many forms but can include imaging sensors capable of performing visible, infrared and/or x-ray imaging. In some embodiments, a processor of ground station 140 can be configured to analyze data provided by the sensors to make a determination regarding the safety of landing UAV 130 at ground station 140. In some embodiments, sensor data captured at ground station 140 can be transported across network 110 for offsite analysis. For example, a pilot of UAV 130 or flight clearance manager could be responsible for issuing landing or takeoff approvals based on a review of the sensor data. In some embodiments, one or more processors operating offsite (at, e.g., UAV service 120) can be configured to scan and analyze the sensor data to make a safety determination and then issue landing or takeoff approval based on the safety determination. Where an obstacle is identified landing or takeoff of UAV 130 can be delayed temporarily or UAV 130 can be diverted to another ground station 140 based on the nature of the detected obstacle. It should be appreciated that in some embodiments, ground station 140 may not use any optical sensors for airspace clearance but instead rely on radar and/or acoustic sensors.

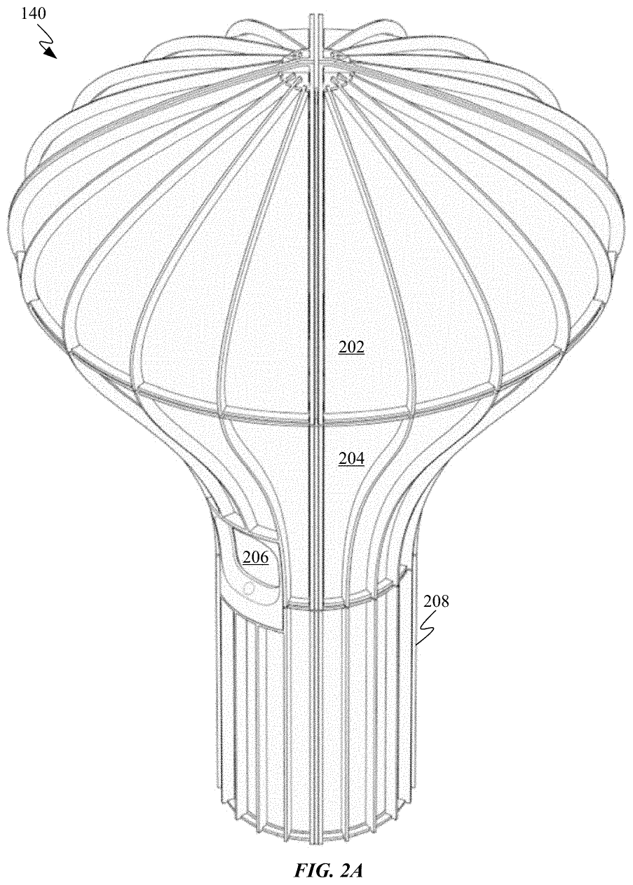

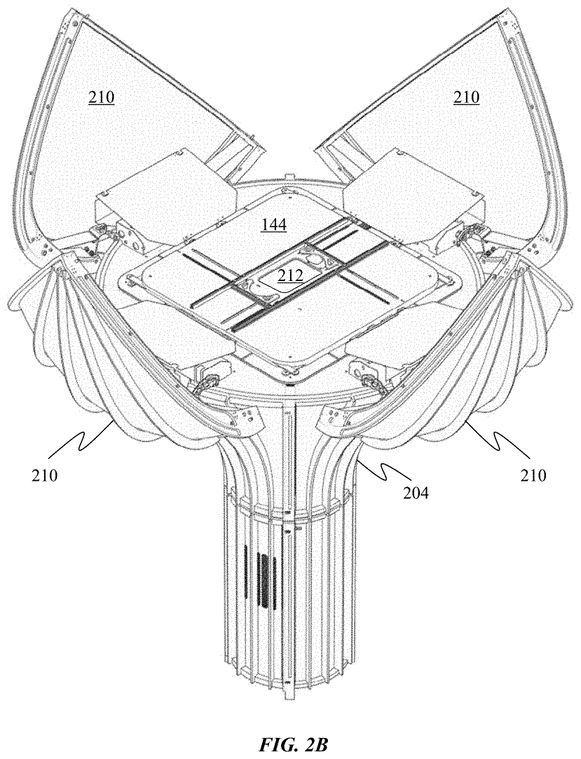

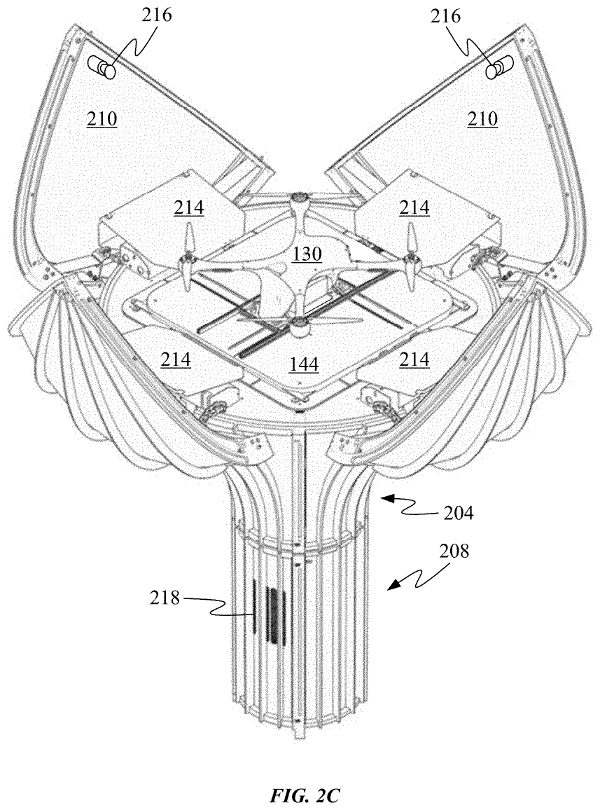

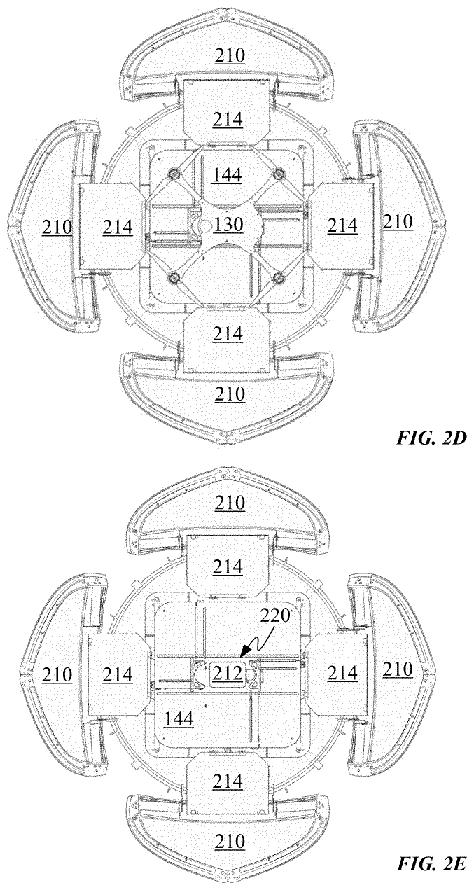

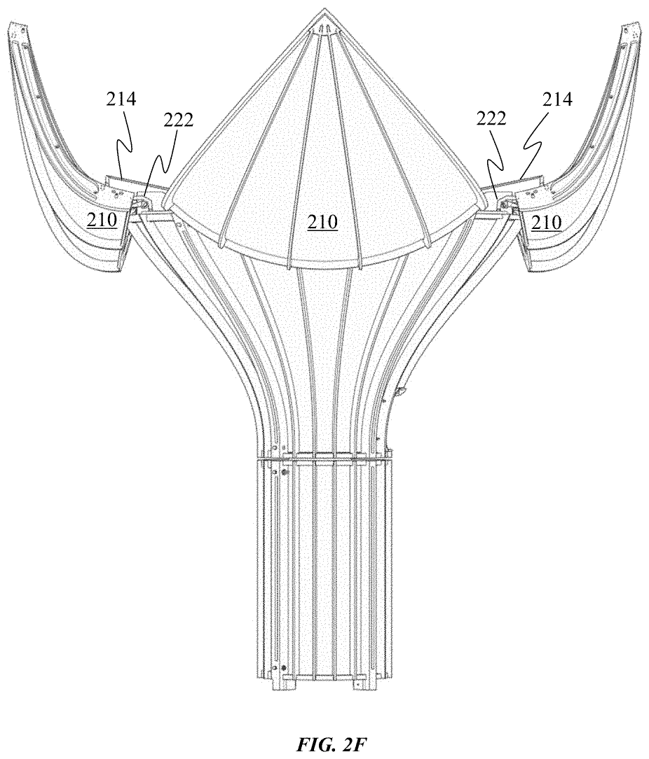

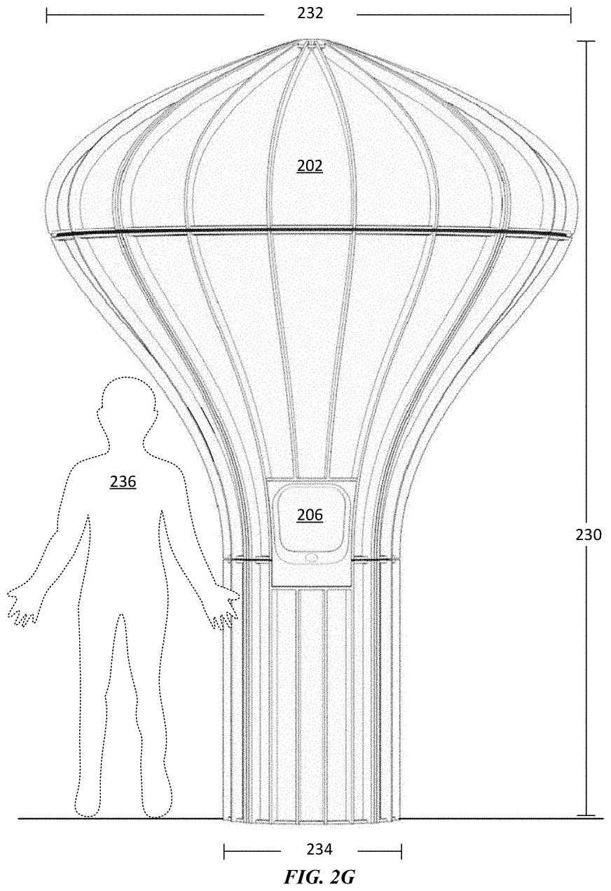

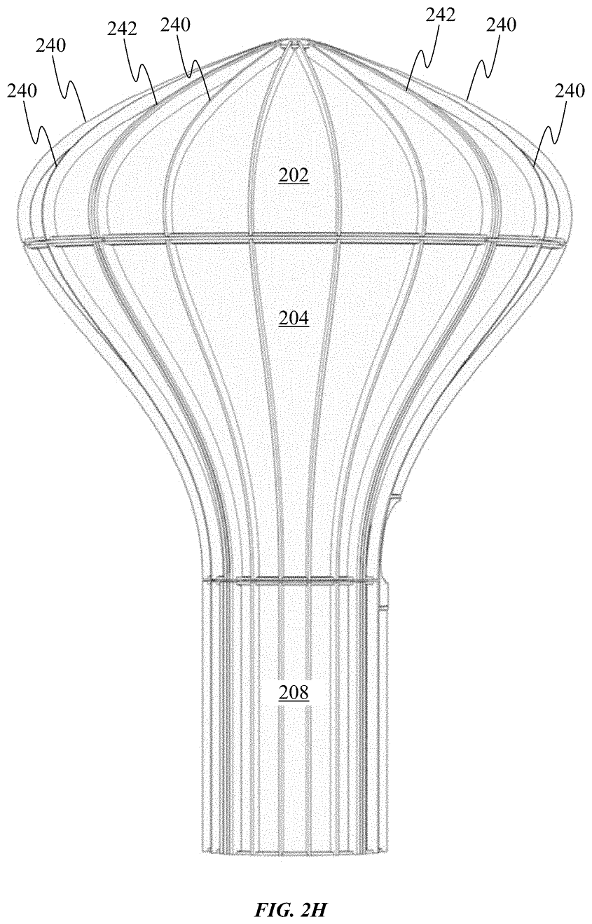

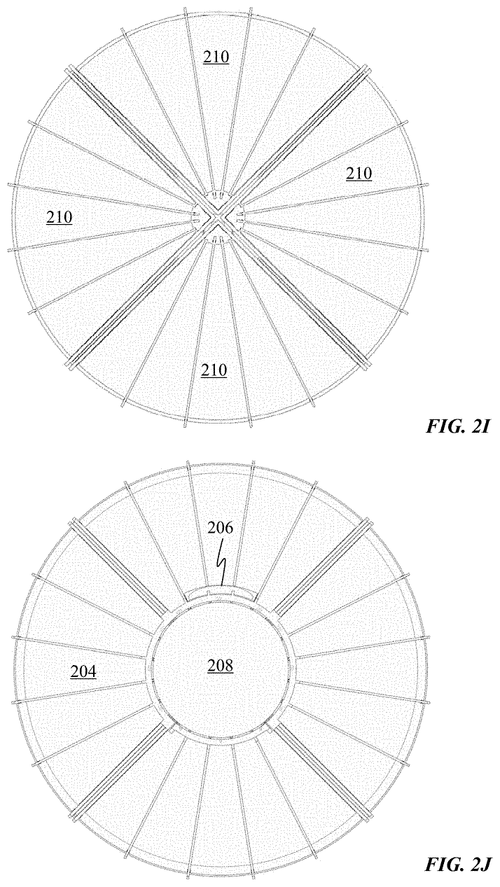

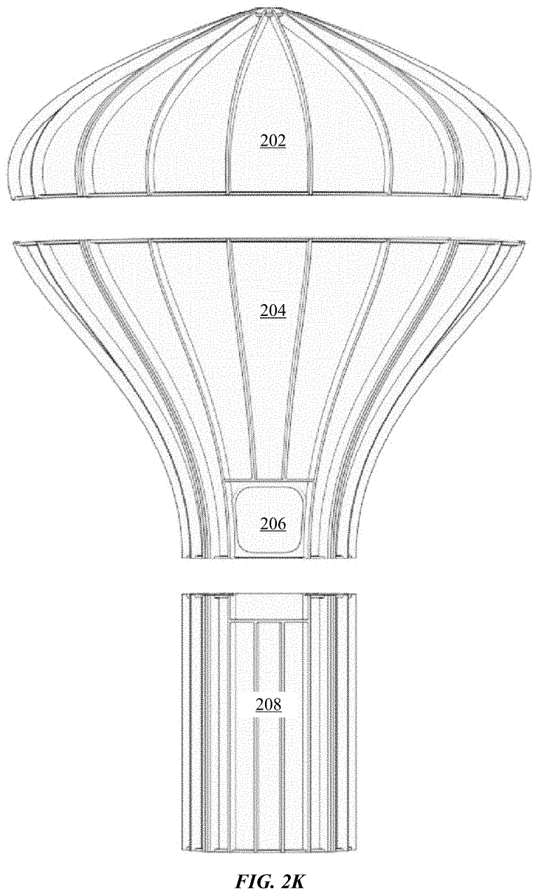

Exchange station 146 can include a payload processing mechanism (e.g., a robotic arm or series of conveyor belts/elevators) to enable the receiving and exchanging of payload containers or payloads. In some embodiments, exchange station 146 can also include a battery exchanging mechanism for exchanging battery of a landed UAV 130. In some embodiments, the battery exchanging mechanism and the payload processing mechanism may be separate mechanisms or may be integrated to form a single mechanism. Ground station 140 is described in more detail below with FIGS. 2A-2K.

As described, ground station 140 can include a landing platform 144 to facilitate the landing of UAV 130. In some embodiments, landing platform 144 can be part of an exchange station 146 (e.g., the user's backyard, a roof of a building. etc.). The landing platform 144 may include a landing sub-system (e.g., an infrared beacon). A more limited exchange station 146 may only be capable of receiving the payload container using the landing platform 144, but may not have the capability of exchanging payload containers and batteries with the UAV 130. In some embodiments, after receiving the payload container, the UAV 130 may relaunch from ground station 140 at the user's location for the next destination (e.g., returning to a distribution facility or another ground station) according to the information provided by UAV service 120.

FIG. 2A illustrates a perspective view of an exemplary ground station 140, consistent with some embodiments of the present disclosure. Ground station 140 includes, for example, a hangar module 202 that contains landing platform 144. Hangar module 202 can include multiple articulating doors or petals that cooperatively shield landing platform 144 from inclement weather and define an area in which UAVs are able to be reloaded and/or inspected between flights. The doors or petals can protect landing platform 144 from dirt, dust, rain, or any external objects (e.g., birds, leaves, etc.). When UAV 130 approaches ground station 140 or is in a landing phase, the doors can open to expose landing platform 144 for landing of UAV 130. Ground station 140 also includes a crown module 204 configured to perform the functions of an exchange station 146 and is located directly below hangar module 202. Crown module 204 includes a storage area for within which packages can be secured while waiting for UAV transportation or customer pickup. Crown module will typically include some form of conveyance such as a robotic arm or series of conveyors/elevators for moving packages and/or spare batteries around within crown module 204 and up to a UAV 130 positioned within hangar 202. Crown module 204 can also include a terminal 206 that includes an interface at which customers are able to deposit or pickup payloads.

Terminal 206 includes at minimum customer and/or payload identification sensors. For example, a customer identification sensor could take the form of an RFID scanner capable of reading identifying information from an RFID badge. Other means of identification are also possible. For example, the sensor could read biometric information from the customer and/or be configured to receive some form of passcode information to authenticate the customer. Once the customer has been identified, terminal 206 can be configured to identify and authenticate the payload. For example, the payload may include an external label or computer-readable bar code identifying its contents. In some embodiments, terminal 206 can include a user input means for receiving identification of the package at terminal 206 and in other embodiments ground station 140 may require pre-authorization for payloads prior to the customer's arrival at ground station 140. Terminal 206 further includes a means for receiving the payload into crown module 204. For example, the payload receiving means can take the form of a tray or conveyor belt capable of receiving one or more different types of payload containers. Once received within crown module 204 one or more sensors can be used to confirm the payload weight and other characteristics of the payload.

For example, a magnetic field detector can confirm the payload is not emitting a magnetic field of a sufficient strength that would have the possibility of interfering with operation or navigation of any of UAVs 130. When the payload contains more sensitive/high value content, the payload may also include its own set of sensors for monitoring the contents of the payload with a transmitter that broadcasts additional information such as payload temperature or overall state of the payload to a receiver within ground station 140. Such a configuration might be useful for medical shipments such as fragile tissue samples or organs for organ transplant. Failure of any sensor readings made regarding the payload can be used as a no-go criteria in which case the payload can be rejected and returned to the customer.

Ground station 140 also includes trunk module 208. Trunk module 208 can include various electronic equipment such as computer processors, memory, long-term data storage devices, temperature regulation systems, power systems, communications equipment and the like that allow ground station 140 to communicate on network 110 and to perform the operations of ground station 140. A weight of trunk module 208 is generally greater than the weight of crown module 204, which is generally greater than the weight of hangar module 202. By positioning heavier equipment at the base of ground module 140 and leaving the upper portions of ground station 140 lighter a good overall stability of ground station 140 can be achieved.

FIG. 2B shows another perspective view of ground station 140 with doors 210 of hangar module 202 open to expose landing platform 144. While a configuration with four doors 210 are depicted, it should be appreciated that a smaller or larger number of doors could be utilized in a similar manner. For example, as few as two doors and as many as eight or ten doors could be utilized to cover and enclose landing platform 144. Depending on an overall scale of ground station 140 a larger number of doors 210 could be desirable over a smaller number of doors. Ground station 140 could scale to accommodate a larger number of UAVs 130 or UAVs 130 of larger or smaller size. As depicted, landing platform 144 includes a central opening 212 through which payloads stored within crown module 204 can be on-loaded and payloads delivered on one of UAVs 130 can be received. Central opening 212 can also be used to deliver a replacement battery to one of UAVs 130 positioned upon landing platform 144.

FIG. 2C shows another perspective view of ground station 140 with UAV 130 disposed atop landing platform 144. In particular, it should be noted that UAV 130 may not always land precisely in a center of landing platform 144. In some embodiments, UAV 130 may need to be shifted so that payloads and/or batteries being maneuvered through central opening 212 can be properly engaged with attachment mechanisms and battery couplings/contacts of UAV 130. Doors 210 can include centering mechanisms 214 that assist in centering UAV 130 on landing platform 144 as doors 210 close to enclose UAV 130 within hangar module 202. Centering mechanisms 214 slide linearly inwards as doors 210 close to align UAV 130 with central opening 212.

Once positioned within hangar module 202. UAV 130 is able to exchange payloads and/or batteries prior to making a subsequent flight. In addition to exchanging a payload and/or battery, the interior of hangar module 202 can be equipped with one or more optical sensors 216 that are configured to provide imagery of the UAV 130 to confirm the overall health and condition of UAV 130. Optical sensors 216 can be configured to scan UAV 130 for signs of impact or trauma. While optical sensors 216 are shown attached to doors 210 it should be appreciated that optical sensors can be located in other positions or distributed throughout an interior of hangar module 202. For example, additional optical sensors could be incorporated into a surface of landing platform 144. In some embodiments, sensors 216 incorporated within landing platform 144 could in addition to being used during an inspection/preflight of UAV 130 after landing, also be configured to provide final alignment information to UAV 130 during landing operations. This type of information could be transmitted to UAV 130 as telemetry data that could be useful in making precise adjustments during high-wind takeoffs or landings in which alignment with landing platform 144 is more difficult. In some embodiments, imagery captured by cameras 216 can be compared with previously captured images to identify any recent damage or changes to UAV 130.

### Engine Run-Up Details

In some embodiments, UAV 130 may be required to perform an engine run-up prior to takeoff. During this run up UAV 130 can remain enclosed within hangar module 202 by doors 210 for noise abatement and/or environmental shielding reasons. One or more of optical sensors 216 can take the form of a high-speed camera capable of optically determining a rotational speed of propellers of UAV 130 during the engine run-up to confirm each of the propellers is operating at a commanded speed. During the engine run-up, UAV 130 will be secured to an upper surface of landing platform 144 to keep it secured to landing platform 144 during the engine run up. In some embodiments, UAV 130 is secured by an articulating arm or some other type of tie down mechanism that engages and holds down a portion of UAV 130. In some embodiments, performance of UAV 130 can also be evaluated by a force sensor incorporated into one or more of the tie downs keeping UAV 130 secured to landing platform 144 during the engine run-up. In some embodiments, an acoustic sensor can be used to monitor for unusual acoustic profile emissions from UAV 130.

It should be appreciated that other sensors and sensor types can be used to evaluate the health and status of UAV 130 while positioned on landing platform 144. For example, a higher acuity inspection might also include one or more x-ray imaging modules for scanning UAV 130 and its propellers for stress fractures or micro-cracking. These automated sensors can alleviate the need for a human to pre-flight UAV 130 prior to each flight. In some embodiments, sensors used to inspect UAV 130 can also be configured to scan the airspace surrounding ground station 140 for obstacles that could impact successful takeoff and/or landing of UAV 130. For example, optical sensors 216 coupled to doors 210 can be configured to perform a 360-degree scan of the airspace surrounding ground station 140 prior to any arrival or departure. In some embodiments, doors 210 can be configured to move to adjust an elevation of optical sensors 216 attached to doors 216. In some embodiments, optical sensors 216 can include their own adjustment mechanisms (e.g. one, two or three axis gimbaled optics) for performing a more thorough search of an area surrounding ground station 140. Optics for some of optical sensors 216 can include a macro lens in the 100-200 mm full frame magnification equivalent range allowing for detailed imagery to be gathered of an entire exterior surface of UAV 130. In some cases, only certain regions of UAV 130, statistically more likely to fail/degrade, can be imaged by the optical sensors with high magnification optics. The sensors of the ground station can be configured to scan for many different types of objects including flying objects such as manned and unmanned aircraft as well as stationary objects such as fallen power lines or trees that could impact the ability of UAV 130 to safely depart from a ground station. The sensors can also be configured to confirm there are no people within a safety zone surrounding the ground station during takeoff or landing operations. While the example of optical sensors 216 are given it should be appreciated that other types of sensors could also be used instead of or in addition to optical sensors 216. For example, acoustic and radar sensors could also be used for detection of aircraft in close proximity to the ground station.

### Thermal Regulation

FIG. 2C also shows how trunk module 208 can include a series of vents 218 for dissipating heat from electronic disposed within trunk module 208. For example, fans within trunk module 208 can be configured to force air across heat sinks associated with heat-generating electronics to convectively cool and maintain acceptable operating temperatures for the electronics within trunk module 208. Crown module 204 can also include vents for effecting temperature regulation of payloads and batteries stored within crown module 204. For example, heating and or cooling components within crown module 204 can be configured to maintain a temperature of certain payloads stored within crown module 204 within a specific range of temperatures. In particularly cold regions or during the winter months it may be helpful for heated air from trunk module 218 to be directed into crown module 204 through either a closable duct between the modules or a separate vent channel designed specifically for distributing heat between the crown and trunk modules. In some embodiments, a battery storage area of the crown can include discrete thermal regulation modules for quickly cooling batteries heated up from demanding use on by one of UAVs 130. In some embodiments, batteries can be positioned within a liquid cooled charging station that can substantially reduce an amount of time needed to recharge an expended battery. The charging station can also include a communication interface that is able to identify a particular battery for use by a particular UAV on a particular flight. That particular battery may then be charged only to a level needed to arrive at its destination given current flight conditions such as wind and inclement weather with a margin of safety included to allow for holding time or changes in flight conditions. In this way, the station can avoid charging every battery to its maximum capacity, thereby increasing a useful lifetime of the batteries.

In some embodiments, thermal regulating modules within crown module 204 can be used to regulate a temperature of a volume of air enclosed by hangar module 202 by leaving a door capable of sealing central opening 212 open. Furthermore, instead of including air vents in crown module 204 or to supplement the air vents in crown module 204, heat can be dissipated from within the crown and hangar modules by allowing doors 210 to separate slightly allowing heat to escape from the volume of air enclosed by hangar module 202. In some embodiments, this could be accomplished by actuating only one of doors 210 by a single degree to limit the amount of air exiting through the gap created between the single door 210 and adjacent doors 210.

FIG. 2D-2E show a top view of ground station 140 with doors 210 in a fully open position with and without UAV 130 respectively. This view shows the size of the opening afforded by doors 210 and the amount of clearance this provides for UAV 130 during landing on landing platform 144. FIGS. 2D-2E also show how centering mechanisms 214 do not cover any portion of landing platform 144 when doors 210 are completely opened as depicted. Furthermore, FIG. 2E also depicts how a central region 220 of landing platform 144 can be slightly recessed in a manner that matches a footprint of UAV 130. In this way, centering mechanisms 214 are able to slide UAV 130 into the slightly recessed central region 220 of landing platform 144, which can help to maintain an alignment of UAV 130 with central opening 212 after centering mechanisms 214 finish aligning UAV 130 with central opening 212.

FIG. 2F shows a side view of ground station 140 with doors 210 in a fully open position. In particular, FIG. 2F shows an angle at which centering mechanisms are disposed with doors 210 in the fully open position. As doors 210 move toward a closed position, an angle of each of centering mechanisms 214 increases with respect to an upward facing surface of landing platform 144. When doors 210 all close concurrently, this results in any misalignment of UAV 130 with landing platform 310 being fixed by centering mechanisms 214. FIG. 2F also shows how doors 210 are rotatably coupled to ground station 140 by four bar mechanisms 222. Four bar mechanisms 222 allow doors 210 to follow a non-radial path that allows for a larger opening to be achieved and for the doors to achieve a solid environmental seal after being joined together.

FIG. 2G shows dimensions of FIG. 2G. In particular, ground station height 230, hangar module width 232 and trunk module width 234. In some embodiments, ground station height 230 can be just over three meters, hangar width can be just over two meters and trunk module width can be about three quarters of a meter. A human silhouette is also shown proximate ground station 140 in order to show a respective average size of a human male next to ground station 140 and how this size places terminal 206 at an appropriate height for interfacing with terminal 206. In some embodiments, a size of ground station 140 can be scaled up to accommodate a larger number of UAVs and/or larger UAVs. In such a case, terminal 206 would remain at a similar height however a width of hangar module 202 can expand substantially and a width of trunk module 208 can also expand to accommodate the additional electronics for supporting the larger configuration and greater weight. A height of crown module 204 could be increased to allow for a width of ground station 140 to increase to accommodate a wider hangar module 202. In some embodiments, this could allow for multiple terminals to be arranged along an exterior of ground station 140. It should be noted that while in some embodiments, terminal 206 can take the form of an opaque face activated only by interaction with an RFID access card, terminal 206 could also include a display screen and touch interface for entering additional details for entering or finalizing a delivery request. FIG. 2G also illustrates how hangar module 202 overhangs a user of ground station 140 interacting with terminal 206. This can be particularly advantageous in terms of safety as it significantly reduces the likelihood of a user interacting with ground station 140 from being hit by debris kicked up or dropped off of a landing or departing UAV 130 by shielding an area directly above the user.

### Structural Support Description

FIG. 2H shows a side view of ground station 140. In particular, curved structural support members 240 are depicted running up and down an exterior of ground station 140. Curved structural support members 242 indicate support members associated with hangar module 202 that are in abutting contact when hangar module 202 is in a closed state. Each of curved structural support members 240 can be made up of three separate segments to accommodate the disassembly of ground station 140 into hangar module 202, crown module 204 and trunk module 208. Curved structural support members 240 function as an exoskeleton for reinforcing construction of ground station 140. In some embodiments, ground station can also include interior support structures for further reinforcement. An exterior surface of ground station 140 can be made up of polycarbonate sheets. While a specific structural configuration of ground station 140 is described it should not be construed as limiting. For example, an exterior of ground station 140 could also be supported primarily from supports interior to ground station 140 and include thicker polycarbonate sheets to form the exterior surface.

FIGS. 2I-2J show top and bottom views of ground station 140, respectively. In particular FIG. 2I shows how doors 210 meet and secure a top portion of ground station 140. In this way, an interior volume defined by hangar module 202 can stay secure from elements such as rain or snow. Furthermore, the contoured top of ground station 140 prevents rain or snow from collecting atop ground station 140. FIG. 2K shows an exploded view of ground station 140 illustrating hangar module 202, crown module 204 and trunk module 208 all separated from each other. Because ground station 140 is able to be divided up into the different modules, as depicted, ground station 140 can be assembled by four people on-site without heavy machinery.

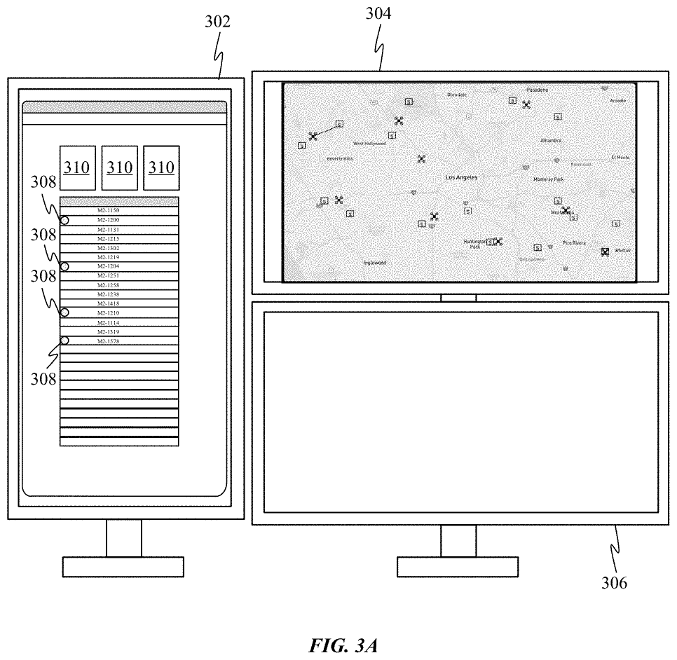

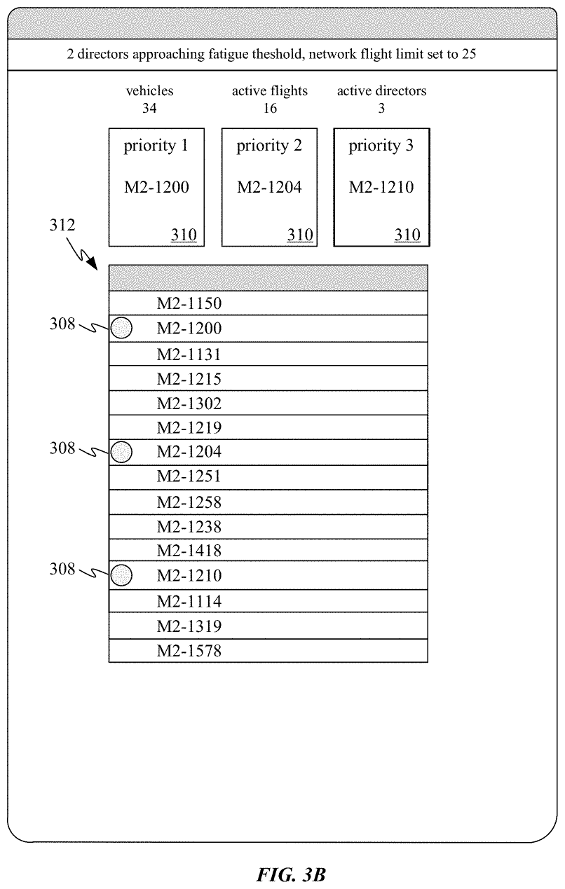

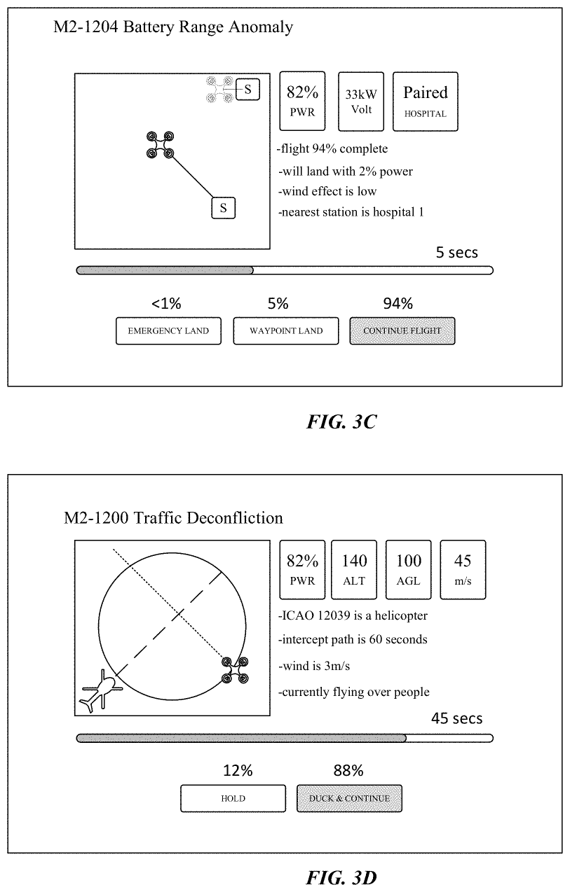

FIG. 3A shows a series of displays configured for directing UAV traffic between ground stations associated with UAV service 120. In particular, displays 302, 304 and 306 can be arranged as shown to display flight status information and help a director to make well informed decisions when unexpected events are identified by UAV service 120. Display 302 is oriented in a portrait orientation and configured to display a list of UAVs that are currently transiting between ground stations. Indicia 308 indicate which of the active UAV flights need direct input for some unexpected event or routing situation that has occurred. The system is configured to autonomously determine the urgency of each of the needed inputs and places the three highest priority decisions at the top of the list in one of alert boxes 310. Display 304 contains a map showing an operating area within which the active UAV flights depicted on display 302 are described. Display 306 is reserved for showing details related to each input needed from the director. While a specific display configuration is shown in FIG. 3A it should be appreciated that the display elements could be rearranged in a single larger display or rearranged in different configurations to suit the preferences of different directors.

FIG. 3A shows a close up view of the data displayed upon display 302. As depicted a designator for each of the active flights is shown in flight listing 312. Furthermore, this closeup view shows how additional detail are provided for the top priority inputs needed in each of alert boxes 310. In some embodiments, the most urgent (i.e. priority 1) input needed will automatically be displayed to the director on display 306, while in other embodiments a director will be able to select one of alert boxes 310 to respond to each of the needed inputs.

FIGS. 3C-3D show examples of how a decision will be provided to a director on display 306 for two different situations. FIG. 3C represents a situation in which a UAV is using up its battery more quickly than originally estimated. The alert shows that UAV M2-1204 is scheduled to land with only 2% power. The director is then asked to decide between three different courses of action with what is determined to be the most likely selected option highlighted. In this case, the system tells the director that 94% of the time directors will opt to have the flight continue. However, if the director believes the battery anomaly could get worse or that adverse winds are likely to pick up and get worse he could opt to emergency land or waypoint land at a ground station located at hospital 1. FIG. 3D represents a situation in which UAV is determined to pass within a threshold range from another aircraft, in this case a helicopter. The director in this case only has two options to choose from, to fly beneath the oncoming traffic or to hold until the traffic passes. In each case the director is given a time frame in which he must make a decision. The depicted displays provide a very expeditious way for directors to quickly understand upcoming decisions and common sense actions for the UAV to make in any given situation. This allows for one director to handle a large number of active UAVs in a safe manner. In some embodiments, a list of UAVs can be shared by multiple directors. In some embodiments, by sharing a large pool of UAVs two directors can safely handle more than twice as many aircraft as a single director could as having two directors managing the pool allows for the directors to more efficiently handle a situation in which multiple decisions need to be made at the same time.

In some embodiments, UAV service 120 can include a risk model configured to determine a number of directors required for maintaining safe supervision over a given number of active flights. This number of required directors can vary based on weather conditions, a determined reliability of the drones themselves and trends in historical safety data. Number of directors required may also depend on an experience level of directors being assigned to monitor active flights. For example, a change in weather or radical change in reliability of the drones could result in an immediate need for additional directors to monitor a given number of active flights. In some embodiments this could result in some active flights needing to be diverted to nearby stations to ensure flight safety is maintained at all times.

In some embodiments, a likelihood of concurrent events can be reduced by purposefully staggering projected takeoff and land times of active flights. As critical alerts are more likely to occur in the takeoff and landing phases this can help in keeping the number of directors needed to supervise a particular number of active flights lower. UAV service 120 can be configured to include hold times into active flight routing when possible to further de-conflict overlapping takeoff and landing times.

A high level overview of the risk model follows: (1) calculate the probability of an event needing director input occurring per second of flight; (2) given multiple drones, calculate the probability of 2 or more overlapping events requiring director input occurring at the same time, e.g., a second event occurring during the same time window that the director needs to resolve a first event; (3) determine the ability for the director to complete all overlapping events within a reasonable margin of safety; and (4) increase the number of drones in the scenario until the director can no longer support overlapping events within the margin of safety.

It should be noted that an event may be deemed to require director input only if it is critical and failure to make a decision could lead to an eventual loss of control or increased probability of risk to the public (air or ground) and termination of the flight will be required to avoid a likelihood of loss of life or high energy collision exceeding a safety threshold. In determining a number of directors needed, escalatable events where the event only become critical if ignored for a long enough period of time, can be excluded from these risk model calculations.

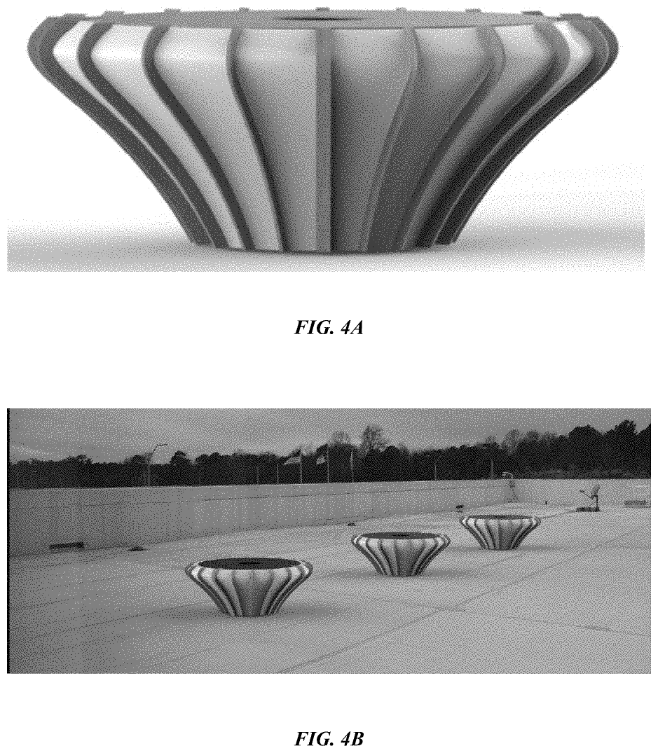

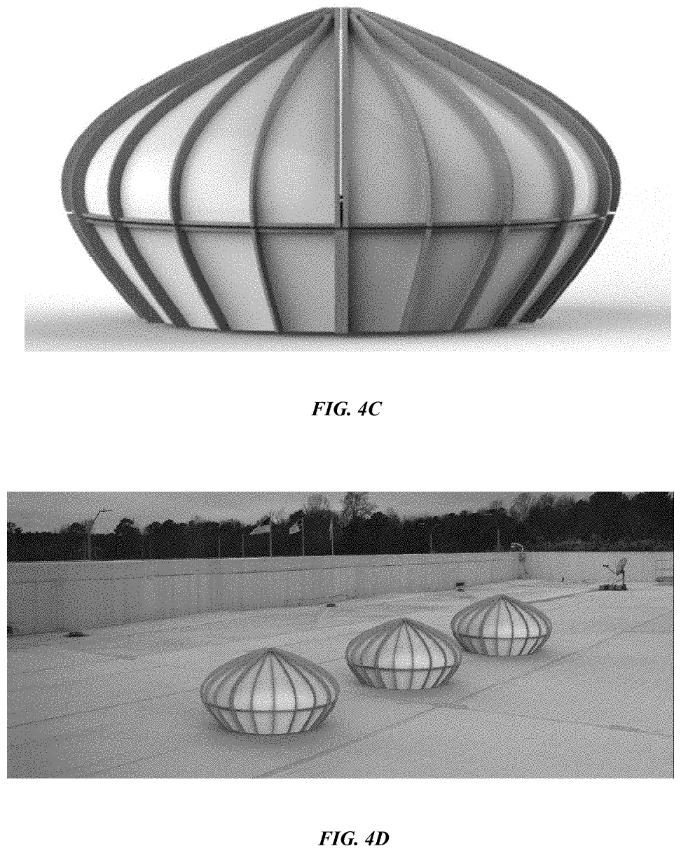

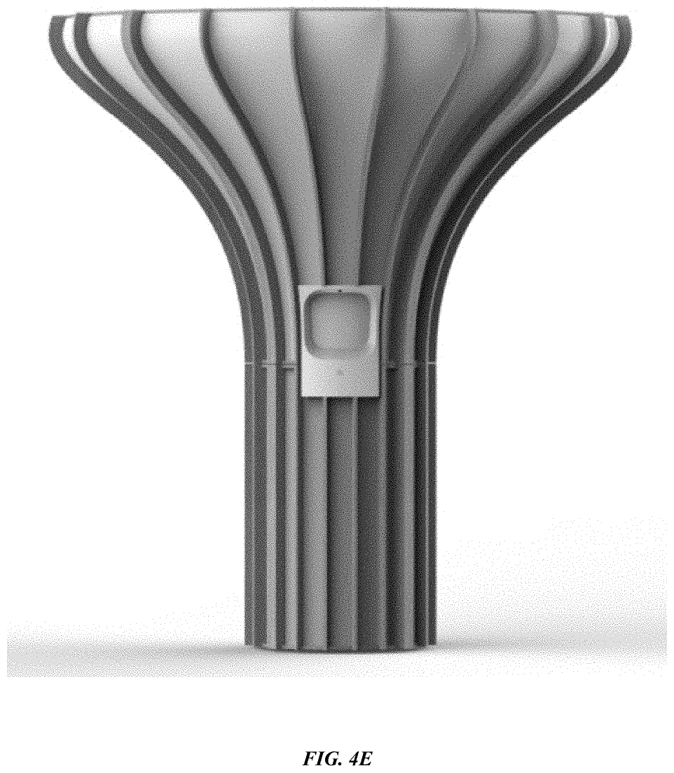

FIGS. 4A-4B show reduced functionality ground stations configured to provide fresh batteries for UAVs traversing longer distances. FIG. 4A shows a side view of a ground station that includes a crown module with a landing platform positioned atop the crown module. As shown in FIG. 4B, these crown modules can be positioned in an out of the way location such as a building rooftop where UAVs traversing longer distances can quickly swap batteries and continue their flight to the next destination or another battery swap out station. In some embodiments a flight director may decide to divert a UAV to one of these stations in the event that head winds are stronger than expected and the UAV is consequently unable to transit the distance to its destination without a new battery.

FIGS. 4C-4D show reduced functionality ground stations configured to provide a location for a UAV to park. FIG. 4C shows a station including primarily a hangar module. In this embodiment, the hangar module can include an additional pedestal section that provides power and other infrastructure components for running the ground station. In some embodiments this type of station may be helpful where a UAV needs to be stored overnight or to wait out an unexpected weather condition. In some embodiments, this type of station can include cameras to help diagnose problems with the UAV reported while the UAV is in flight to another destination. After gathering this data and sending it back to the flight director, the flight director may be able to determine whether the drone can continue on its flight or whether maintenance personnel may be required to repair the UAV before further transits can be undergone.

FIG. 4E shows a reduced functionality ground station lacking a hangar module. In particular, the reduced functionality station can allow for pickup and dropoff of payloads but would be unable to perform inspections on the UAV or provide a shelter in which the UAV could remain if needed. This type of station might be particularly useful in regions where inclement weather such as rain or snow is less likely as it lacks the ability to protect the landing platform from the buildup of snow or rain.

It should be noted that, despite references to particular computing paradigms and software tools herein, the computer program instructions with which embodiments of the present subject matter may be implemented may correspond to any of a wide variety of programming languages, software tools and data formats, and be stored in any type of volatile or nonvolatile, non-transitory computer-readable storage medium or memory device, and may be executed according to a variety of computing models including, for example, a client/server model, a peer-to-peer model, on a stand-alone computing device, or according to a distributed computing model in which various of the functionalities may be effected or employed at different locations. In addition, references to particular algorithms herein are merely by way of examples. Suitable alternatives or those later developed known to those of skill in the art may be employed without departing from the scope of the subject matter in the present disclosure.

It will also be understood by those skilled in the art that changes in the form and details of the implementations described herein may be made without departing from the scope of this disclosure. In addition, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A payload transportation system, comprising:
a ground station for an unmanned aerial vehicle (UAV), comprising:
a landing platform;
an exchange station configured to receive payloads from and attach payloads to a UAV positioned upon the landing platform;
a plurality of sensors, wherein a subset of the plurality of sensors are configured to monitor and scan airspace proximate the ground station for obstacles; and
a processor configured to issue instructions authoring takeoff and landing operations of the UAV based on sensor readings generated by the subset of the plurality of sensors.

2. The payload transportation system as recited in claim 1, wherein the subset is a first subset and wherein a second subset of the plurality of sensors is configured to capture one or more images of the UAV positioned upon the landing platform.

3. The payload transportation system as recited in claim 2, wherein the processor is further configured to issue instructions to cancel takeoff of the UAV in response to the processor determining that the one or more images captured by the second subset of the plurality of sensors show damage to the UAV.

4. The payload transportation system as recited in claim 2, wherein one or more sensors of the second subset of the plurality of sensors comprises a macro lens.

5. The payload transportation system as recited in claim 2, wherein the plurality of sensors comprises an x-ray imaging device configured to capture images of the UAV for detection of stress fractures or micro-cracking.

6. The payload transportation system as recited in claim 2, wherein the ground station further comprises a centering mechanism configured to position the UAV in a central region of the landing platform such that the UAV is within a field of view of the second subset of the plurality of sensors.

7. The payload transportation system as recited in claim 2, wherein the obstacles are flying objects within the airspace.

8. The payload transportation system as recited in claim 2, wherein the second subset of the plurality of sensors is configured to image only a first portion of the UAV that is statistically more likely to fail than a second portion of the UAV.

9. The payload transportation system as recited in claim 1, wherein the landing platform defines an opening and the exchange station is configured to receive the payloads from and attach the payloads to the UAV through the opening.

10. The payload transportation system as recited in claim 9, wherein the exchange station is further configured to receive a battery from and attach a battery to the UAV through the opening.

11. The payload transportation system as recited in claim 1, further comprising:
one or more doors configured to open and close to allow entry of the UAV into an interior of the ground station, wherein the landing platform is disposed within the interior of the ground station.

12. The payload transportation system as recited in claim 1, wherein the processor is co-located with the ground station.

13. A method, comprising:
monitoring and scanning an airspace proximate a ground station for obstacles using a subset of a plurality of sensors of the ground station; and
issuing instructions authorizing takeoff and landing operations of an unmanned aerial vehicle (UAV) from a landing platform of the ground station based on sensor readings generated by the subset of the plurality of sensors.

14. The method as recited in claim 13, further comprising attaching a payload to the UAV positioned upon the landing platform using an exchange station of the ground station.

15. The method as recited in claim 13, wherein the subset is a first subset and wherein the method further comprises capturing one or more images of the UAV positioned upon the landing platform using a second subset of the plurality of sensors.

16. The method as recited in claim 15, further comprising issuing instructions to cancel takeoff of the UAV in response to the processor determining that the one or more images captured by the second subset of the plurality of sensors show damage to the UAV.

17. The method as recited in claim 13, further comprising issuing instructions to delay takeoff of the UAV in response to the processor identifying one or more obstacles within the airspace proximate the ground station.

18. The method as recited in claim 13, wherein the instructions are issued by a processor off-site from the ground station.

19. A non-transitory computer-readable storage medium storing instructions configured to be executed by one or more processors that cause the ground station to perform a method, the method comprising:
monitoring and scanning an airspace proximate the ground station for obstacles using a subset of a plurality of sensors of the ground station; and
issuing, using a processor, instructions authorizing takeoff and landing operations of an unmanned aerial vehicle (UAV) from a landing platform of the ground station based on sensor readings generated by the subset of the plurality of sensors.

20. The non-transitory computer-readable storage medium as recited in claim 19, wherein the subset is a first subset and wherein the method further comprises:
capturing one or more images of the UAV positioned upon the landing platform using a second subset of the plurality of sensors; and
issuing instructions to cancel takeoff of the UAV in response to the processor determining that the one or more images captured by the second subset of the plurality of sensors show damage to the UAV.
